(19) United States
(12) Patent Application Publication
(10) Pub. No.: US 2013/0159995 A1
(43) Pub. Date: Jun. 20, 2013

(54) DOWNLOADABLE APPLICATION DYNAMIC MANAGEMENT DEVICE FOR COMMUNICATION EQUIPMENT

(71) Applicants: Christophe Senot, Nozay (FR); Dimitre Davidov Kostadinov, Nozay (FR)

(72) Inventors: Christophe Senot, Nozay (FR); Dimitre Davidov Kostadinov, Nozay (FR)

(73) Assignee: ALCATEL LUCENT, Paris (FR)

(21) Appl. No.: 13/697,219

(22) PCT Filed: Jan. 12, 2011
(86) PCT No.: PCT/FR2011/050058

§ 371 Date: Feb. 27, 2013

(30) Foreign Application Priority Data
May 11, 2010 (FR) 1053646

(51) Int. Cl. G06F 9/445

(52) U.S. Cl. CPC G06F 8/62
USPC 717/178

(57) ABSTRACT

A device (D) is designed to manage applications for a piece of communication equipment (EC) of a user, capable of connecting to a communication network (R). This device (D) comprises i) a search system (MR) configured to determine, through the network (R), applications that may be downloaded and used by the communication equipment (EC) and that are potentially useful to the user based on at least one parameter, and ii) a management system (MG) configured to order the communication device (EC) to download to a storage system (MS2) at least one of the applications thus determined in order to offer it to the user, and to control the installation of each proposed application selected by the user in order for it to be potentially used at least temporarily.

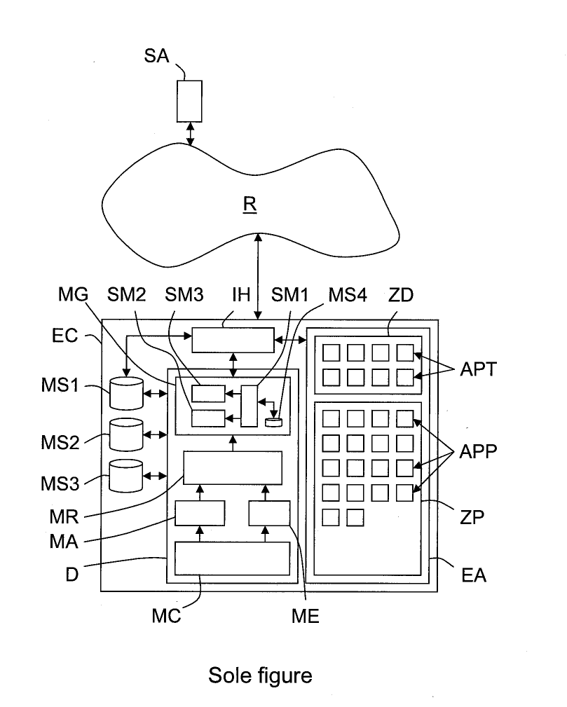

The invention pertains to user communication equipment, potentially mobile ones, and more specifically the downloading of (computer) applications by such communication equipment.

The number of (computer) applications made available to users of communication equipment (wired or wireless), such as through the Internet, is constantly growing; these users have increasing difficulty not only in finding applications that temporarily or permanently meet their needs, but also in being notified of new applications that might be of interest to them.

Due to these difficulties, several software tools have been recently proposed to users to facilitate access to applications. Such is the case for the tool called Chorus® (marketed by Envio Networks). This tool enables users to rank applications that they have downloaded and used, and lets friends and family of these users know about applications that they have not yet downloaded and for which the average rankings are greater than a threshold. The primary disadvantage of this tool lies in the fact that the applications that it proposes only rarely meet the actual needs of the users because these users, while being friends or family, do not always share the same interests or tastes and/or do not have the same requirements. Additionally, this solution only proposes lists of applications that are derived from other lists containing very limited numbers of applications, such that they do not consider most of the applications that are actually available, but which have not yet been downloaded by the other users. Moreover, each user must manually download each application, and then manually install it, and potentially manually uninstall it if he or she no longer uses it. Lastly, this tool accounts neither for the current context of the user nor the current activity of that user, so that the applications that are proposed to him or her have little chance of being of immediate interest.

This is also true of the tools called Yappler® and AppsFire®. These tools enable users to create their own customized lists of applications, and potentially to update them automatically, and then to exchange these lists with friends and/or members of a social network. The disadvantages of these two tools are very similar to those of Chorus®.

This is also true of the tool called SideBar®. For each user, this tool periodically selects, from among new applications, those that meet criteria resulting from responses that the user gave to questions about his or her demographic information (age, gender, socio-professional category) and his or her preferences, and then sends each user a description of each application selected for him or her. As with the previous tools, each user must manually download each application that was selected for him or her and is of interest, and then he or she must install it manually, and potentially uninstall it manually if he or she no longer uses it. Additionally, this tool considers neither the current context of the user, nor the current activity of the user, and, therefore, the applications that are proposed to him or her have little chance of being of immediate interest.

This is also true of the tool called Apple Genius®. This tool determines commonalities among applications that a user has downloaded and applications that the user has not yet downloaded in order to propose new applications to him or her. The primary disadvantage of this tool lies in the fact that it only proposes new applications that have at least one function in common with an application that a user has previously downloaded, and thus other new applications are never proposed even though some of them might be of interest. Additionally, this tool considers neither the current context of the user, nor the current activity of the user, and, therefore, the applications that are proposed to him or her have little chance of being of immediate interest.

An object of the invention is therefore to remedy some or all of the aforementioned drawbacks.

To that end, it proposes a device, designed to manage applications for a piece of communication equipment for a user able to connect to a communication network, comprising:
a search system configured (or designed) to determine, through the network and based on at least one parameter, applications that may be downloaded and used by the communication device that are potentially useful to the user, and
a management system configured (or designed) to order (or trigger) the communication device to download, into a storage system, at least one of the applications thus determined, in order to propose it to the user, and to control installation of each proposed application selected by the user so that it may potentially be used, at least temporarily.

The management device according to the invention can have other features, applied separately or in combination:
each parameter may be selected from among (at least) the current activity of the user, contextual information, a user profile, user preferences, the remaining storage capacity of the storage system, a maximum quantity of data authorized for downloading, the bandwidth of the network able to be used by the communication device, network coverage, an estimated duration of the current activity of the user, a predicted change of context or activity, and the energy available in the communication equipment;
   contextual information may be selected from among (at least) the applications in use by the user, the location of the user, the current time, the current date, information that is contained in an electronic planner for the user, the social environment of the user, the applications that the user habitually uses when he or she carries out the current activity, applications used by communication equipment belonging to users located near the user in question;
      it may comprise an analysis system configured to deduce the current activity of the user from certain contextual information and/or location information for the user and/or the prior activities of the user;
         The analysis system may be configured to deduce future contextual information and/or a valid period for current contextual information for the current activity of the user;
         The analysis system may be configured to deduce a future activity for the user from the current activity of this user and potential prior habits of this user;
its management system may be configured to order the downloading of each application thus determined into the memory system dedicated to temporary storage;
its management system may be configured to propose the applications downloaded into the memory system by displaying them in a dedicated area of a display screen on the communication equipment;
   its management system may be configured to control the display in the dedicated area of a number of proposed applications that is less than or equal to an initial threshold (that may potentially be configured by the user);
its management system may be configured to determine each application previously installed that has become unnecessary within the current context and a deduced potential future context and/or from the current activity and a deduced potential future activity, and order each application deemed unnecessary be uninstalled;
   its management system may be configured to increment by one unit a value that represents the number of times an application was downloaded by the communication equipment and used by its user, and when an application has become unnecessary, either to order its deletion from said memory system when its associated value is less than a second threshold, or to store it in another dedicated memory system when its associated value is greater than or equal to the second threshold, so as to be able to propose it again later without having to download it again;
      its management system may be configured to propose to the user the transfer of an application stored in the memory system to another memory system that is dedicated to permanent application storage, if the value associated with this application is greater than a third threshold;
its management system may be configured to analyze the usage of downloaded applications based on a current context and/or a current activity, so as to establish a match between application types and contexts and/or activities;
it may be configured to receive from the network a list of applications currently being used by neighbouring communication equipment, and/or to transmit a list of applications that are being used by its communication equipment.

The invention also proposes communication equipment for a user, capable of being connected to a communication network (potentially mobile or cellular) and equipped with a management device of the type described above.

Other characteristics and advantages of the invention will become apparent upon examining the detailed description below, and the attached drawing in which the sole FIGURE schematically and functionally illustrates a communication network to which are connected an application server and a piece of user communication equipment incorporating an example embodiment of the management device described for the invention.

The drawing may serve not only to complete the invention, but also to contribute to defining it, if need be.

The invention proposes a device D designed to dynamically manage applications for a piece of communication equipment EC of a user, capable of connecting to a communication network R.

In what follows, it is assumed by way of non-restrictive example that the users are equipped with wireless communication equipment EC, such as mobile telephones (potentially smartphones), which may connect to a wireless communication network R (for example a mobile (or cellular) network). However, the invention is not limited to communication networks of this type. Neither is it limited to communication equipment of this type. In fact, it refers to any type of wired or wireless communication network, and therefore any type of communication equipment capable of connecting with a wired or wireless communication network and capable of downloading and using applications. Therefore, the communication network R may also be a wired network (for example ADSL), and the communication equipment EC may also be desktop or laptop computers, landline telephones, connected personal digital assistants (PDAs), content receivers (such as home gateways or set-top boxes (STBs)), or connected game consoles, for example.

The sole FIGURE schematically depicts an example (communication) network R, to which are connected, firstly, a piece of (communication) equipment EC belonging to a user who is a client (whether directly or indirectly (roaming)) of the operator of said network R and, secondly, a network device SA (such as an application server (or “application store”)) from which stored applications are available for downloading.

On the one hand, it should be noted that several, or even many, pieces of (communication) equipment EC may be connected to the (communication) network R and, on the other hand, that several network devices SA, each storing applications for downloading, may be connected directly or indirectly to the network R.

As shown in the sole FIGURE, the communication equipment EC comprises, in particular, a first memory system MS 1, a human/machine interface IH and a display screen EA.

The first memory system MS1 is configured to permanently store so-called permanent applications APP. Here “permanent storage” normally refers to long-term storage, as opposed to temporary storage taking place over a short term. It should be understood that the definition provided above does not prevent an application downloaded with the goal of being permanently stored from being deleted from the first memory system MS1 very soon after it is downloaded if it does not satisfy the user.

This first storage system MS1 may come in any form known to specialists, such as a memory (potentially a purely software-based memory).

The display screen EA is configured so as to display data. Therefore, it may, for example, feature a main area ZP that may display icons representing permanent applications APP that are stored in the first memory system MS1 and which were previously installed.

The human/machine interface IH is configured to provide an interface between the equipment EC and the user (for example through the display screen EA that may be a touch screen and/or a keyboard and/or a mouse (or similar selection apparatus)).

The invention proposes to associate a management device D with each piece of equipment EC to dynamically manage the applications that it might download.

In the non-restrictive example illustrated in the sole FIGURE, the (management) device D is part of the equipment EC. However, it could be external to the equipment EC while being coupled to it. Therefore, the device D described for this invention may be constructed in the form of software (or computer) modules, a combination of electronic circuits and software modules, or electronic circuits.

As illustrated in the sole FIGURE, a device D according to the invention comprises at least search system MR and management system MG.

The search system MR is configured to determine, through the network R and based on at least one parameter, applications that may be downloaded (here from the application server SA) and used by the communication equipment EC, after storage in the second memory system MS2, and that are potentially useful to the user of the equipment EC.

In a way, the search system MR acts as a decision engine.

It should be noted that the selection of applications may, for example, be similar to the resolution of the knapsack problem where the sack capacity is the lower of the physically available space and the quantity of data available for download, and where one assigns each application a size and a relevance score (value). More specifically, here, this involves selecting the set of applications that will in particular maximize user satisfaction (for example through the sum of relevance scores assigned to the applications) and for which the size is less than or equal to the remaining capacity in the sack (or the second memory system MS2). As indicated above, one or more other additional parameters and/or one or more constraints may also enter into consideration in the selection process. Thus it is possible to decide not to select redundant applications and/or to give priority to applications that have a very high relevance score even if they have a big size.

In the non-restrictive example shown in the sole FIGURE, the second memory system MS2 is part of the equipment EC. However, this is not obligatory. Additionally, in the non-restrictive example shown in the sole FIGURE, the second memory system MS2 is independent of the first memory system MS1. However, it could be a part of the latter (MS1).

This second storage system MS2 may come in any form known to specialists, such as a memory (potentially a purely software memory).

Any type of parameter known to specialists and able to allow the selection (or filtration) of applications may be used. Therefore, it is possible, for example, to use at least one of the parameters mentioned below by way of a non-restrictive example (and preferably several):
the current activity of the user (that is to say the action that he or she is in the process of carrying out, such as making a telephone call, using a specific piece of software, running, walking, or standing in (or in front of) a store or a theatre);
contextual information, such as, and not limited to, the applications currently in use by the user, the location of the user (learned from a locating system that is either part of the equipment EC or part of the network R), the current time, the current date, information that is contained in an (accessible) electronic planner for the user, the social environment of the user (list of friends or membership in a social or professional network, for example), the applications that the user habitually employs during the current type of activity (which requires storing activity types matched with applications used in a correspondence table);
applications that are currently being used by pieces of communication equipment EC′ that belong to users located near the user of the equipment EC in question;
the storage capacity remaining in the second memory system MS2;
the bandwidth on the network R that may be used by the equipment EC in question (which is accessible through the network R);
the network R coverage (which defines any potential shadow areas, high-traffic areas, and low-traffic areas);
the estimated duration of the current activity of the user;
a predicted change of context;
a predicted change of activity;
the energy available for equipment EC (which depends upon the level of charge in the battery for mobile or portable equipment EC);
a user profile for the person operating the equipment EC in question (here “user profile” means a set of digital data that define the identity of a user such as his or her demographic data (age, gender, occupation) and interests (or preferences or habits or even pastimes) for one or more topics), said profile being stored in the equipment EC or within a network device (for example by the operator of the network R) accessible through the latter (R);
preferences of the user of the equipment EC in question, provided, for example, by said user (these preferences may be stored in the equipment EC or in a network device accessible through the network R);
the maximum quantity of data authorized for downloading (this quantity may be either defined by the user or based on at least one other parameter, such as at least one of those mentioned above;
the price of the application and/or the margin earned by the supplier of the application and/or the operator on the downloaded application.

As illustrated in non-restrictive fashion in the sole FIGURE, at least some of the search parameters may be determined by means (or modules) that are part of the device D. Therefore, the device D may for example comprise a collection system MC tasked with collecting contextual information (in particular the information mentioned above). It should be noted that such a collection system MC may potentially process some of the collected data to deduce contextual information from them. Therefore, it may potentially transform a geographic position (such as a GPS point) into an address for a known location or store, or match a social environment with a social network in order to determine friends or relatives located near the user in question, or to deduce, from accelerometer data or successive geographic positions, the fact that the user in question is standing still, walking or running in a given direction, or using a means of transport.

Also, as shown in non-restrictive fashion in the sole FIGURE, the device D may for example comprise analysis system MA tasked, at least, with deducing the current activity of the user from certain contextual information and/or location information for the user and/or prior activities of the user. To that end, it is coupled with the collection system MC. It should be noted that this analysis system MA may also be configured to deduce future contextual information and/or the valid period for the current contextual information from the current activity of the user. It may also be configured to deduce a future activity of the user from the current activity of the user and the potential prior habits of this user.

For example, it may provide semantic descriptions of current or future activities and current or future contexts. By way of non-restrictive examples, it may:
Deduce the activity “user is watching a movie” from a context such as “user located in a movie theatre”,
Use a sequence of successive contexts (or changes of context) to deduce a current activity,
Deduce the future activity of the user from his or her current activity (for example if the user is playing sports, it may deduce that he or she will soon go home),
Deduce the current activity and/or a future activity from old activities, when the user always carries out the same sequence of actions (or activities) within a given context (such as always returning home by the same path, or always going to his or her workplace by the same path, or always returning home after going running, or always going shopping on Friday evening at the same store).

Also, as shown in non-restrictive fashion in the sole FIGURE, the device D may for example comprise estimation system ME tasked with estimating the quantity of data (and therefore, indirectly, the number of applications) that may be downloaded in consideration of at least one of the aforementioned parameters, and in particular the current or future context, the current or future activity, the estimated duration of the current activity of the user, a predicted change of context, the remaining storage capacity in the second memory system MS2, and the energy available in the equipment EC. To that end, it is coupled with the collection system MC.

The management system MG is configured, on the one hand, to order (or trigger) the communication equipment EC to download to the second memory system MS2 at least one of the applications determined by the search system MR, in order to propose it to the user (for potential selection through the human/machine interface IH), and on the other hand, to control the installation of each application proposed to the user and selected by him or her so that it can potentially be used at least temporarily.

As shown in non-restrictive fashion in the sole FIGURE, the management system MG may comprise a first sub-module SM1 tasked with controlling the display of icons for proposed applications APT, through the human/machine interface IH and a second sub-module SM2 tasked with controlling the installation of each application APT selected by the user through this same human/machine interface IH.

It should be noted that the second memory system MS2 is preferably dedicated to the temporary storage of applications that have been downloaded. These applications APT are called temporary.

As shown in non-restrictive fashion in the sole FIGURE, the management system MG may be configured advantageously to propose temporary applications APT (that have only been downloaded) to the user by displaying icons that represent them in a dedicated area ZD of the display screen EA of the equipment EC. As shown, this dedicated area ZD is for example located just above (or alternatively just below) the main area ZP in which the icons representing permanent applications APP (stored in the first memory system MS1) are displayed.

It should be noted that the management system MG may potentially be configured to control the display in the dedicated area ZD of a number of proposed applications APT that is less than or equal to a first threshold S1, that may potentially be configured by the user.

The management system MG may also be configured, on the one hand, to determine each temporary application APT that was installed previously and that became unnecessary given the current context and a deduced potential future context and/or the current activity and a deduced potential future activity, and, on the other hand, to order each temporary application APT deemed unnecessary to be uninstalled.

As shown in non-restrictive fashion in the sole FIGURE, the management system MG may comprise a third sub-module SM3 in charge of uninstalling a temporary application APT previously selected by the user each time it is necessary to do so.

It should be noted that the uninstalling of a temporary application APT may be accompanied by the deletion of this temporary application APT from the second memory system MS2 or else the transfer of this temporary application APT from the second memory system MS2 to the dedicated third memory system MS3. This choice is made by the management system MG (and more specifically their third sub-module SM3). In this case, the third sub-module SM3 may for example be configured to increment by one unit a value V that represents the number of times a temporary application APT has been downloaded by the equipment EC and then used by the user. When a temporary application APT becomes unnecessary (due to the fact that it has not been used by the user for a duration greater than a threshold), the third sub-module SM3 may either order its deletion from the second memory system MS2 if its associated value V is lower than a second threshold S2 (V<S2), or its storage in the third memory system MS3 if its associated value V is greater than or equal to the second threshold S2 (V≦S2). It should be understood that the transfer of an unnecessary temporary application APT to the third memory system MS3 is intended to allow it to be proposed again later without having to download it again, while making it invisible to the user in the main ZP and dedicated areas ZD.

In the non-restrictive example illustrated in the sole FIGURE, the third memory system MS3 is part of the equipment EC. However, it could be a part of the device D. Additionally, in the non-restrictive example shown in the sole FIGURE, the third memory system MS3 is independent of the first memory system MS1. However, it could be a part of the latter (MS1).

This third memory system MS3 may come in any form known to specialists, such as a memory (potentially a purely software memory).

It should be noted that the values V, associated with the temporary applications APT stored in the second memory system MS2, may be stored in fourth memory system MS4. In the non-restrictive example shown in the sole FIGURE, the fourth memory system MS4 is part of the management system MG of the device D. However, it could be part of the equipment EC.

The management system MG may also potentially be configured to propose to the user to transfer a temporary application APT stored in the second memory system MS2 to the first memory system MS1 if the value V associated with this temporary application APT is greater than a third threshold S3 (itself greater than the second threshold S2 (S3>S2). this option is intended to make an application permanent when it had been temporary up to that point. This proposal is made via the human/machine interface IH. It should be noted that once an application APT is transferred to the first memory system MS1, its icon will appear only in the main area ZP of the display screen EA.

Additionally, the management system MG may also potentially be configured to analyze the usage made by the user of the downloaded temporary applications APT based on a current context and/or a current activity. In effect, this makes it possible to establish a match between application types and contexts and/or activities potentially useful to the search system MR when it determines applications to be downloaded. In this case, the management system MG of the device must store usage information, for example in the fourth memory system MS4.

It should be noted that the device D may potentially be configured to receive from the network R a list of applications that are being used within neighbouring pieces of equipment EC′, and/or to transmit the list of applications that are being used within its own piece of equipment EC. This transmission may potentially be carried out in broadcast mode, or directly by each piece of communication equipment EC, or indirectly through a network device.

An example of a scenario likely to occur to a user A, and the consequences that this induces within his or her piece of equipment EC due to the presence of a device D, are described below.

The user A prepares to take a plane to go to Spain. When he or she arrives at the airport, the device D on his piece of equipment EC may, for example, spontaneously download applications on air traffic, electronic check-in, maps of the airport, information (or news) if the user A is sitting, and/or a price comparison if the user A is walking through a commercial mall area in the airport.

These applications are determined according to the current preferences and/or activities and/or needs of the user A. It should be noted that the content of each application may potentially be customized.

Once the airplane has taken off, all downloaded applications become unnecessary, except the one on air traffic (useful for the return flight), and will then be deleted from the equipment EC.

When the user A arrives at the Spanish destination airport, the device D within his or her equipment EC may for example spontaneously download applications on renting a car, various means of public transit (trains, long distance or local buses, or taxis), and/or maps of the main city near which the airport is located.

When the user leaves the airport, all of the applications become unnecessary, except for those on air traffic (useful for the return flight, and the map of the main city (soon to become useful), and are therefore deleted from the equipment EC.

The city being Madrid, when the user A walks near the Prado museum, the device D of his or her equipment EC may, for example, spontaneously download applications about the Prado as it knows that its user A is an art connoisseur and, for example, that these applications are being used by other users (as it has been alerted to this fact). Therefore, there is a double benefit for the user A because he or she is alerted to the presence of the Prado near him or her, and he or she has access to all the public information useful for touring the Prado.

The invention offers a certain number of benefits, including:
It makes it possible to offer users applications that have been determined from among all those that are accessible through a network,
It makes it possible to opportunistically offer users applications that may be useful to those users at a given moment, in consideration of their context and/or activity, and therefore that may anticipate the needs of the users,
It offers a new means of discovering new applications,
It enables relevant applications to become immediately usable, without user intervention.

The invention is not limited to the embodiments of the management device and communication equipment described above, which are only given by way of example; rather, it encompasses all variants that specialists may envision within the framework of the claims below.

1. A device for managing applications for a piece of communication equipment for a user capable of connecting to a communication network, wherein it comprises i) a search system configured to determine, without intervention from said user, through said network applications able to be downloaded and used by said communication equipment and potentially useful to said user based on at least one parameter, and ii) a management system configured to order said communication equipment to download to a memory system at least one of the applications thus determined, in order to propose it to said user, and to control the installation of each proposed application selected by said user so that it may potentially be used at least temporarily.

2. A device according to claim 1, wherein said search system is configured to determine each application based on at least one parameter selected from a group comprising at least the current activity of the user, contextual information, a profile of said user, the preferences of said user, the remaining storage capacity in said memory system, a maximum quantity of data that has been authorized for download, the bandwidth on the network able to be used by said communication equipment, the network coverage, an estimate of the duration of the current activity of said user, a predicted change in context, a predicted change in activity, and the energy available in said communication equipment.

3. A device according to claim 2, wherein said contextual information is selected from a group comprising at least the applications currently in use by said user, the location of said user, the current time, the current date, the information contained in an electronic planner of said user, the social environment of said user, the applications that said user habitually uses when he or she carries out said current activity, and the applications used by communication equipment belonging to users located near said user.

4. A device according to claim 3, wherein it comprises an analysis system configured to deduce the current activity of said user from certain contextual information and/or location information for this user and/or previous activities of said user.

5. A device according to claim 4, wherein said analysis system is configured to deduce future contextual information and/or a valid period for the current contextual information of said current activity of the user.

6. A device according to claim 4, wherein said analysis system is configured to deduce a future activity of the user from said current activity of this user and potential prior habits of said user.

7. A device according to claim 1, wherein said management system is configured to order said communication equipment to download each application thus determined into the memory system dedicated to temporary storage.

8. A device according to claim 1, wherein said management system is configured to propose said applications downloaded to the memory system by displaying them in a dedicated area of a display screen of said communication equipment.

9. A device according to claim 8, wherein said management system is configured to control the display in said dedicated are of a number of proposed applications less than or equal to a first threshold.

10. A device according to claim 1, wherein said management system is configured to determine each previously installed application that has become unnecessary considering the current context and a deduced potential future context and/or the current activity and a deduced potential future activity, and to order each application deemed unnecessary to be installed.

11. A device according to claim 10, wherein said management system may be configured to increment by one unit a value that represents the number of times an application was downloaded by said communication equipment and used by said user, and when an application has become unnecessary, either to order its deletion from said memory system when its associated value is less than a second threshold, or to store it in another dedicated memory system when its associated value is greater than or equal to the second threshold, so as to be able to propose it again later without having to download it again.

12. A device according to claim 11, wherein said management system is configured to propose to said user to transfer an application stored in said memory system to another memory system dedicated for permanent application storage, when said value associated with this application is greater than a third threshold.

13. A device according to claim 1, wherein said management system is configured to analyze the usage of said downloaded applications based on a current context and/or a current activity, so as to establish a match between application types and contexts and/or activities.

14. A device according to claim 1, wherein it is configured to receive from said network a list of applications that are being used within neighbouring pieces of communication equipment, and/or to transmit a list of applications that are being used within said communication equipment.

15. A piece of communication equipment for a user, capable of connecting to a communication network, wherein it comprises a management device according to claim 1.
